(19) United States
(12) Patent Application Publication
(10) Pub. No.: US 2025/0093510 A1
(43) Pub. Date: Mar. 20, 2025

(54) POSITION MEASURING SYSTEM

(71) Applicant: DR. JOHANNES HEIDENHAIN GmbH, Traunreut (DE)

(72) Inventors: Wolfgang HOLZAPFEL, Obing (DE); Michael STEPPUTAT, Traunstein (DE)

(21) Appl. No.: 18/830,736

(22) Filed: Sep. 11, 2024

(30) Foreign Application Priority Data
Sep. 15, 2023 (DE) 102023208964.5

(51) Int. Cl. G01S 17/48; G01S 7/481

(52) U.S. Cl. CPC G01S 17/48; G01S 7/4814; G01S 7/4817

(57) ABSTRACT

A position measuring system for determining spatial position information includes at least one light source and at least one optical receiving unit. The receiving unit has a scanning grating and an optoelectronic detector arrangement whose light-sensitive surfaces are oriented in the direction of the scanning grating. The detector arrangement has two detector regions arranged in a detection plane mirror-symmetrically to a first axis of symmetry that extends through the center of the detector arrangement in the detection plane, in which the first axis of symmetry is oriented orthogonally to the longitudinal extension direction of the detector regions. The two detector regions have the shape of an isosceles, acute-angled triangle whose triangle tips are oriented with the tip angle in the direction of the center of the detector arrangement.

### CROSS-REFERENCE TO RELATED APPLICATIONS

The present application claims priority to Application No. 10 2023 208 964.5, filed in the Federal Republic of Germany on Sep. 15, 2023, which is expressly incorporated herein in its entirety by reference thereto.

### FIELD OF THE INVENTION

The present invention relates to a position measuring system for determining spatial position information.

### BACKGROUND INFORMATION

PCT Patent Document No. WO 01/38828 describes an optical position measuring system that is arranged as a spatial 2D angle measuring system and can be used to determine spatial position information. On the one hand, the position measuring system includes a transmission unit, which is arranged on a measuring object movable in space whose spatial position and orientation (pose) is to be determined; a suitable light source, for example, can act as the transmission unit. On the other hand, one or more optical receiving units are arranged stationary opposite the movable transmission unit, each of which has a scanning grating and an optoelectronic detector arrangement whose light-sensitive surfaces are oriented in the direction of the scanning grating. With the aid of such a system, the position of the transmission unit in space can be determined via so-called multi-angulation. For this purpose, the direction of the line of sight to the transmission unit as seen from the respective receiving unit is determined using two angle measurements. If the relative position of two receiving units is known, the position of the transmission unit can be determined from the intersection of the determined lines of sight. This measuring principle can be extended by adding further transmission units, so that the spatial pose of transmission units can also be determined via corresponding measurements. The foregoing document, which is expressly incorporated herein by reference thereto, provides further details of such a measuring principle.

### SUMMARY

Example embodiments of the present invention provide improvements to position measuring systems with regard to signal generation and thus increase the accuracy of the position measurement.

The position measuring system is used to determine spatial position information. It includes at least one light source and at least one optical receiving unit, which has a scanning grating and an optoelectronic detector arrangement whose light-sensitive surfaces are oriented in the direction of the scanning grating. The detector arrangement has two detector regions, which are arranged in a detection plane mirror-symmetrically to a first axis of symmetry that extends through the center of the detector arrangement in the detection plane. The first axis of symmetry is oriented orthogonally to the longitudinal extension direction of the detector regions. The two detector regions respectively have the shape of an isosceles, acute-angled triangle whose apexes are oriented with the apex angle in the direction of the center of the detector arrangement.

For example, the detector arrangement has two further detector regions which are identical to the two first detector regions and are arranged mirror-symmetrically to a second axis of symmetry that extends in the detection plane through the center of the detector arrangement and is oriented orthogonally to the first axis of symmetry.

It is possible, that the triangles respectively have an apex angle γ for which γ/2=7.125°+/−5° applies, and that the apexes touch with the apex angle in the center of the detector arrangement.

According to example embodiments, a plurality of individual detector elements can be arranged periodically and parallel to one another in each detector region along an arrangement direction that is oriented perpendicular to the longitudinal extension direction of the detector regions.

It may be provided that the detector elements are rectangular in shape and the rectangle longitudinal axes are oriented parallel to the longitudinal extension direction of the detector region, and that each fourth detector element is electrically interconnected along the arrangement direction, so that four phase-shifted output signals for further processing result from the scanning of a stripe pattern falling on the detector arrangement.

For example, the ratio of detector element width to detector element periodicity is 1:7.

It may also be provided that the following relationship is satisfied for the change in the detector element length along the arrangement direction:

$$dh\_D / dx = + / - 8$$

in which h_D represents the detector element length and x represents the arrangement direction.

It is also possible that the scanning grating is arranged in a plane parallel to the detection plane and includes a periodic arrangement of grating regions along at least one grating direction, in which the grating direction is at an angle of 45° to the longitudinal extension direction of the detector regions.

For example, it is provided that the scanning grating is arranged as a transmissive, combined amplitude-phase grating, in which an identically formed, opaque amplitude grating structure is arranged in each grating region, and a phase shift layer is arranged along each grating direction in every second grating region above the amplitude grating structure.

It is possible that the phase shift layer is formed with regard to material and layer thickness such that it results in extensive suppression of the 0th diffraction order and all even diffraction orders for a certain wavelength range and for a certain angle of incidence range.

Furthermore, the amplitude grating structure can be formed such that for a certain wavelength range a preferential transmission into the +/−1st diffraction orders and an extensive suppression of odd diffraction orders results.

According to example embodiments, it may be provided that the scanning grating is arranged on that side of a transparent cover plate of the receiving unit that is oriented in the direction of the detector arrangement.

For example, the combined amplitude-phase grating has a checkerboard structure with a periodic arrangement of square grating regions along two orthogonal grating directions.

It may also be provided that the amplitude grating structure includes opaque grating bars that are arranged parallel to one another along the two grating directions and have at least partially different grating bar widths, and that the amplitude grating structures in grating regions that are arranged adjacent along a grating direction are formed mirror-symmetrically to an axis of symmetry that extends along the boundary of the adjacent grating regions.

It is also possible that the light source is arranged as an LED that emits radiation in the wavelength range λ=850 nm+/−20 nm and has a coherence length of less than or equal to 7 μm.

The measures described herein provide that signal-distorting influences, such as undesirable subharmonics, harmonics, and 2D spatial frequencies are suppressed or filtered out. Furthermore, it is provided that a sufficient signal strength of the detected measurement signals results in a large distance range between the light source and receiving unit for all detected reception angles. In this manner, it is possible to significantly increase the accuracy of the position measurement in space.

Further features and aspects of example embodiments of the present invention are described in more detail below with reference to the appended schematic Figures.

### BRIEF DESCRIPTION OF THE DRAWINGS

FIG. 1 illustrates the measuring principle of the optical position measuring system described herein.

FIG. 2a is a top view of a detector arrangement of the optical position measuring system.

FIG. 2b is an enlarged view of a detector region of the detector arrangement illustrated in FIG. 2a.

FIG. 3 is a top view of a scanning grating of the optical position measuring system.

FIG. 4a is a top view of a part of the scanning grating illustrated in FIG. 3.

FIG. 4b is an enlarged view of the scanning grating illustrated in FIG. 4a in conjunction with a cross-sectional view thereof.

FIG. 5 is a side-by-side view of the detector arrangement and the scanning grating illustrated in FIGS. 2a and 3.

### DETAILED DESCRIPTION

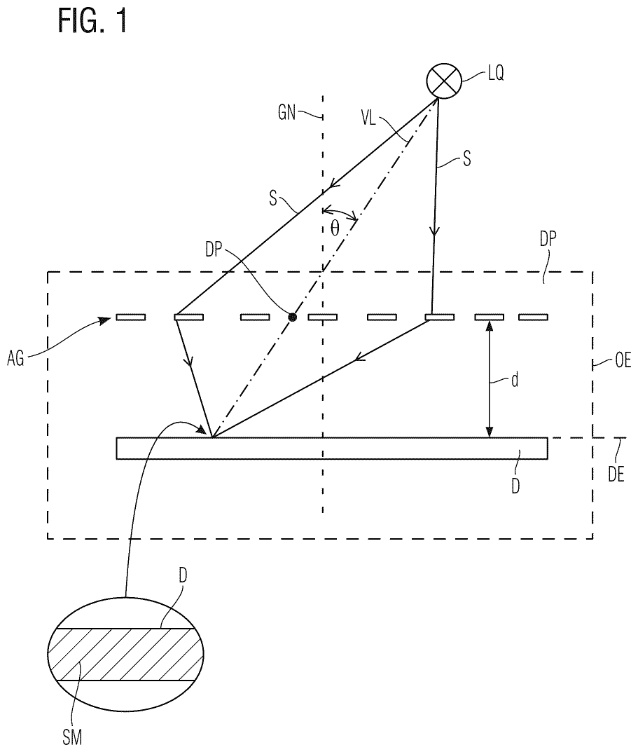

Based on the highly schematic view of FIG. 1, the underlying measuring principle of the optical position measuring system and its basic structure are explained below.

The corresponding optical position measuring system includes at least one light source LQ and at least one optical receiving unit OE. The light source LO can, for example, be arranged on a measuring object movable in space, the spatial position and orientation (pose) of which can be determined with the aid of the stationary optical receiving unit OE.

The light source LQ is, for example, arranged as an approximated point light source, e.g., as an LED. For example, the light source LQ has only a small coherence length, which is selected to be less than or equal to 7 μm; it emits radiation in the wavelength range λ=850 nm+/−20 nm. The light source LQ emits divergent beam bundles S in the direction of the optical receiving unit OE, i.e., no collimating optics are arranged upstream of the light source LQ.

The optical receiving unit OE includes a scanning grating AG arranged on the input side and an optoelectronic detector arrangement D arranged stationary downstream of the scanning grating AG in the direction of beam propagation. The scanning grating AG is arranged on that side of a transparent cover plate DP of the receiving unit OE that is oriented in the direction of the detector arrangement D. All components of the receiving unit OE are arranged in a housing. The light-sensitive surfaces of the detector arrangement D are oriented in the direction of the scanning grating AG and define a detection plane DE in the optical receiving unit OE. As illustrated in FIG. 1, the detection plane DE is arranged parallel and at a certain distance d from the scanning grating AG in the receiving unit OE. European Patent Document No. 4 145 083, which is expressly incorporated herein in its entirety by reference thereto, describes a suitable configuration of the optical receiving unit OE.

The interaction of the light bundles S divergently emitted by the light source LQ with the scanning grating AG results in a spatially structured light field in the form of a stripe pattern SM in the detection plane DE of the detector arrangement D via a grating self-imaging, which pattern is schematically illustrated in the lower region of FIG. 1 in a partial top view of the detection plane DE of the detector arrangement D. If the light source LQ moves relative to the optical receiving unit OE, the stripe pattern SM moves across the detector arrangement D in the detection plane DE. By detecting the stripe pattern position or position change with the aid of the detector arrangement D, the intersection point DP of the connecting line VL between the light source LQ and the detector arrangement D through the scanning grating AG can be determined. The position of the intersection point DP through the scanning grating AG in combination with the known distance d between scanning grating AG and detector arrangement D results in the angle of incidence θ relative to the grating normal GN.

FIG. 1 only illustrates the relationships in relation to the drawing plane, i.e., the drawing plane represents the measuring plane in relation to the angle of incidence θ of the light. In addition, as mentioned above, a second angle measurement is carried out along a further measuring plane that is oriented perpendicular to the drawing plane. Thus, in such an arrangement of the device described herein, a 2D angle measurement is ultimately performed between the light source LQ and the optical receiving unit OE. The two angle measurements are incremental measurements, i.e., when the light source LQ moves from a first position to a second position, the resulting angle changes in the two measuring planes are recorded with the aid of the optical position measuring system. In a typical configuration, one signal period of the position-dependent incremental signals generated via the detector arrangement D corresponds to an angular change of a few mrad.

In order to provide for the most accurate possible measurement of the stripe pattern position and to avoid possible signal drops with varying distances of light source LQ and receiving unit OE, a number of measures in the optical position measuring system may be provided, e.g., with respect to the detector arrangement D and the scanning grating AG in the optical receiving unit OE. These measures are primarily necessary because the sine gratings ideally required for measurement by grating self-imaging are not available as scanning gratings for manufacturing reasons; binary gratings must be used instead. Ideal sinusoidal gratings should be understood to be gratings whose transmission varies in sin² shape depending on the position. If such sinusoidal gratings are used, only the +/−1st diffraction orders resulting in transmission would contribute to grating self-imaging in the detection plane. In order to ensure sufficiently accurate angle measurements despite the use of binary gratings, the measures explained below may be provided in order to minimize the undesirable effects caused by binary gratings as far as possible. Variants of detector arrangements D or scanning gratings AG are explained in more detail below and are optimized by suitable measures for use in the optical position measuring system.

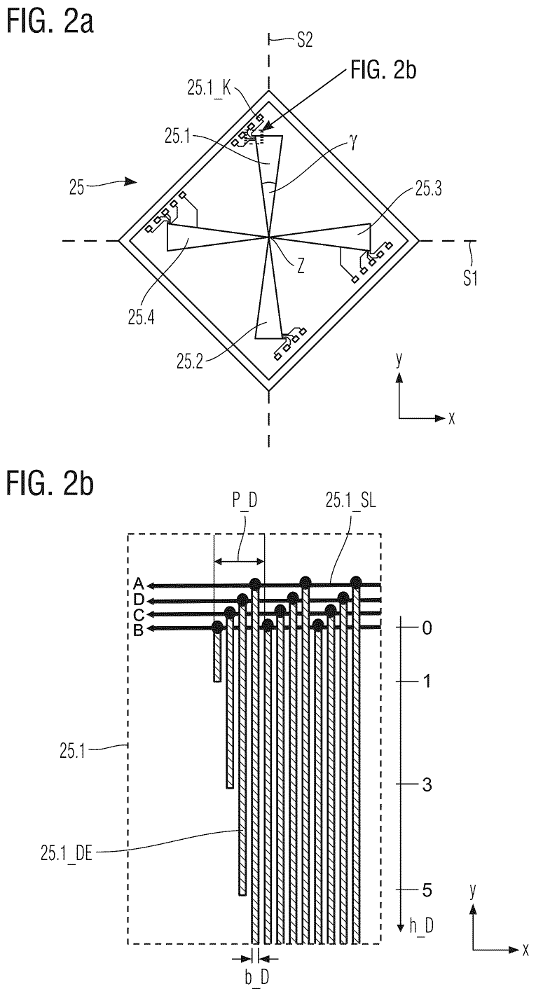

A detector arrangement 25 for a 2D angle measurement is illustrated in FIGS. 2a and 2b.

FIG. 2a is a top view of a detector arrangement 25 of the optical position measuring system. For example, the detector arrangement 25 has four detector regions 25.1 to 25.4, each of which has the shape of an isosceles, acute-angled triangle. The apexes, with the identical apex angle γ, are all oriented in the direction of the center Z of the detector arrangement 25. The center Z represents the geometric center of gravity of the detector arrangement surface. The arrangement of the detector regions 25.1 to 25.4 is such that two respective detector regions 25.1, 25.2 or 25.3, 25.4 are arranged mirror-symmetrically to one of the two axes of symmetry S1, S2 of the detector arrangement 25. The axes of symmetry S1, S2 extend in the detection plane through the center Z of the detector arrangement 25 and are oriented orthogonally to one another. Specifically, in the example illustrated in FIG. 2a, the two detector regions 25.1, 25.2 are arranged mirror-symmetrically to the first axis of symmetry S1, and the two detector regions 25.3, 25.4 are arranged mirror-symmetrically to the second axis of symmetry S2. The detector regions 25.1, 25.2 and 25.3, 25.4, which are arranged mirror-symmetrically to one of the two axes of symmetry S1 and S2, respectively have a common longitudinal extension direction y and x. Thus, as illustrated in FIG. 2a, the two detector regions 25.1, 25.2 extend along the y-direction and the detector regions 25.3, 25.4 extend along the x-direction. The longitudinal extension direction y of the two detector regions 25.1, 25.2 is thus oriented orthogonally to the first axis of symmetry S1, and the longitudinal extension direction x of the two detector regions 25.3, 25.4 is oriented orthogonally to the second axis of symmetry S2.

The two detector regions 25.1, 25.2, whose longitudinal extension direction is oriented along the specified y-direction, are used to detect a stripe pattern movement along the measuring direction x. A stripe pattern movement along the measuring direction y can be detected via the two other detector regions 25.3, 25.4, whose longitudinal extension direction is oriented respectively along the x-direction.

In the detector arrangement 25, it is provided that the apexes of the detector regions 25.1 to 25.4 touch one another with the apex angle γ in the center Z of the detector arrangement 25. In the present example or for the present application, the apex angle γ is respectively selected with a measuring volume of approx. 1 m³ and an angle of incidence range of approximately +/−50° so that γ/2=7.125°+/−5° applies. However, if the requirements for the measuring range change, a deviating range for the apex angle γ can also be provided, for which γ/2=7.125°+[−5°, +20°] can apply.

The length of a detector region 25.1 to 25.4 along its longitudinal extension direction x or y is respectively 5.376 mm, and the base length of the triangle envelope is respectively 1.344 mm.

An enlarged detailed view of the detector region 25.1 is illustrated in FIG. 2b. As illustrated in FIG. 2b, a plurality of individual, rectangular detector elements 25.1_DE are arranged periodically and parallel to one another in the detector region 25.1. The periodic arrangement takes place in the detector region 25.1 along an arrangement direction x, which is oriented perpendicular to the longitudinal extension direction y of the detector region 25.1. The arrangement direction x is thus oriented parallel to the measuring direction x of the detector region 25.1. The rectangle longitudinal axes of the detector elements 25.1_DE are, as illustrated, oriented parallel to the longitudinal extension direction y of the detector region 25.1. Suitable detector elements 25.1_DE include, for example, optoelectronic detector elements in the form of photodiodes.

As also illustrated in FIG. 2b, every fourth detector element 25.1_DE is electrically interconnected in the detector region 25.1 along the arrangement direction x. This takes place via four bus lines 25.1_SL, which respectively electrically connect every fourth detector element 25.1_DE. In this manner, four periodic output signals A, B, C, D, phase-shifted by 90°, are generated from the scanning of the stripe pattern in the detection plane and made available for further processing. In the detector arrangement 25, four contact terminals 25.1_K outside the detector region 25.1 are connected to the four bus lines 25.1_SL of the detector region 25.1, as illustrated in FIG. 2a.

As part of the signal processing, the 0° output signal A and the 180° output signal C are combined, e.g., in a conventional manner, via a push-pull circuit to form a first incremental signal S0; the 90° output signal B and the 270° output signal D are also combined via a push-pull circuit to form a second incremental signal S90, which is phase-shifted by 90° in relation to the first incremental signal S0.

For example, the width b of a detector element 25.1_DE is b_D=12 μm, and the gaps between the detector elements 25.1_DE have a width of 9 μm. The detector element periodicity P in relation to in-phase detector elements P is P_D=84 μm, i.e., the ratio of detector element width b_D and detector element periodicity P_D is b_D:P_D=1:7. A total of 64 detector elements 25.1_DE are provided in the detector region 25.1, resulting in a maximum width of the detector region 25.1 or a base length of the triangle envelope of 1.344 mm.

FIG. 2b illustrates, in detail, the arrangement of the detector elements 25.1_DE in the left base angle area of the detector region 25.1. Accordingly, the detector element that supplies the output signal B is arranged at the left edge of the detector region 25.1; it is located at a distance of ⅛·P_D from the upper left corner point of the triangular detector region 25.1. The detector elements 25.1_DE, which supply the output signals C, D, A etc., respectively follow at a distance of ¼·P_D.

As also illustrated in FIG. 2b, the detector elements 25.1_DE have a different detector element length h_D along the arrangement direction x due to the triangular shape of the detector region 25.1 described above. In the illustrated section, the detector element length h_D increases from left to right up to the center of the detector region 25.1. From the center of the detector region 25.1, the length of the detector elements 25.1_DE then decreases again toward the right. Thus, the first detector element 25.1_DE from the left, which supplies the output signal B, has a detector element length h_D=1·P_D, The second detector element (output signal C) has the detector element length h_D=3·P_D, the third detector element (output signal D) has the detector element length h_D=5·P_D, etc.

For example, the following relationship applies to the change in the detector element length h_D along the arrangement direction x:

$$dh\_D / dx = + / - 8 ,$$

in which h_D represents the detector element length, and x represents the arrangement direction.

Within the detector region 25.1, the detector elements 25.1_DE are arranged mirror-symmetrically to a longitudinal axis of symmetry of the detector region 25.1, which extends along the y-direction through the apex. The two detector elements 25.1_DE, which supply the output signals A, B, are arranged on both sides adjacent to the longitudinal axis of symmetry. The detector element which supplies the output signal A is positioned to the left of the axis of symmetry, and the detector element with the output signal B is positioned to the right of the axis of symmetry. The respective distance to the longitudinal axis of symmetry is +/−⅛·P_D. The detector element with the output signal D follows on the left-hand side at a distance of ¼·P_D, the detector element with the output signal C follows on the right-hand side at a distance of ¼·P_D, etc.

The detector region 25.2 is arranged identically with regard to the arrangement of detector elements, in which detector elements in the two detector regions 25.1, 25.2, which supply output signals A, B, C, D in phase with one another, are located opposite one another mirror-symmetrically to the first axis of symmetry S1.

In contrast, the arrangement of detector elements in the two detector regions 25.3, 25.4 is rotated by 90°. Within each detector region 25.1 to 25.4, the configuration and wiring of the detector elements is respectively substantially identical.

In addition to the configuration of the scanning grating, which is described below, such a configuration of the detector arrangement 25 and, for example, the configuration and wiring of the detector elements 25.1_DE in the various detector regions 25.1 to 25.4 helps to suppress or filter out unwanted intensity components of the grating self-imaging, which would otherwise cause errors in the determination of the 2D angular positions of the light source. Such unwanted signal components are, for example, harmonics or 2D spatial frequencies, which can be eliminated via the filter effect of the detector arrangement 25. Furthermore, the corresponding configuration of the detector regions 25.1 to 25.4 ensures that a reliable 2D angle measurement is possible in a large distance range between the light source and the receiving unit. For example, distances between the light source and the receiving unit in the range between 0.2 m and 1.5 m are possible. In this range, the angle of incidence of the beam bundles from the light source can be measured in an angle of incidence range of +/−50° in relation to a normal to the scanning grating.

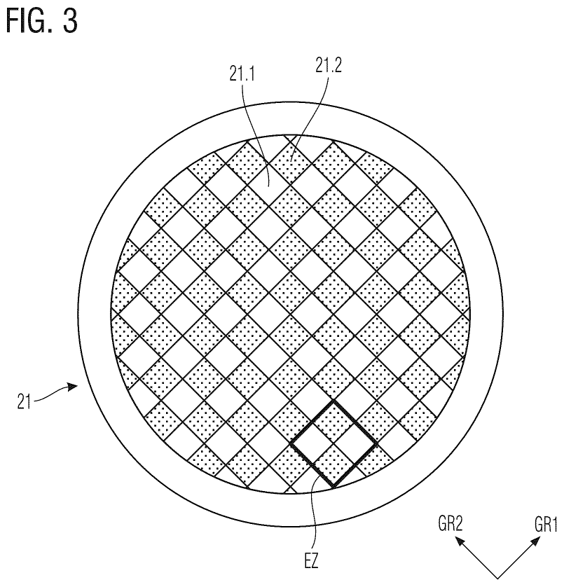

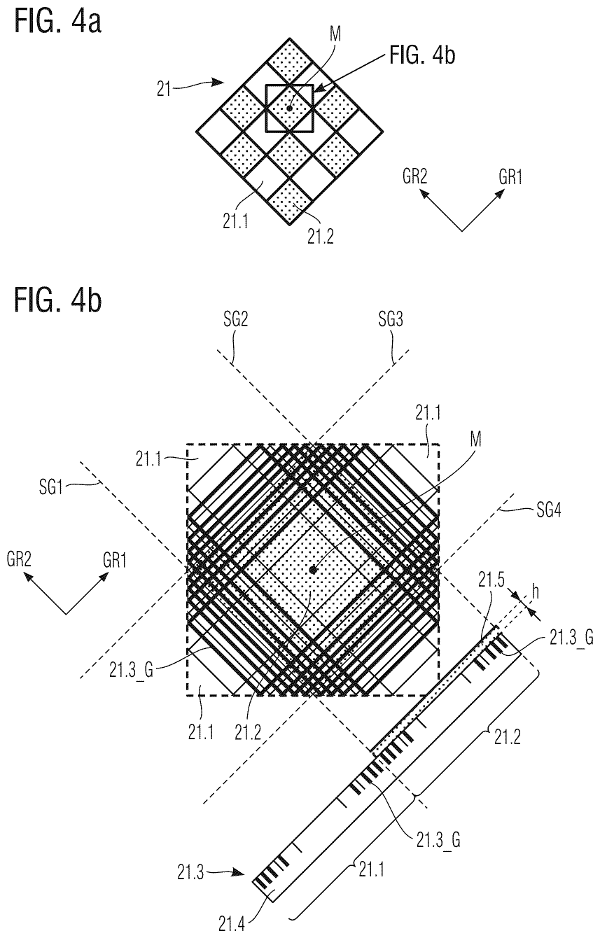

Further measures, which are also aimed at suppressing interference in the device, are described with reference to the following explanation of an exemplary arrangement of the scanning grating in the optical receiving unit. FIG. 3 is a schematic top view of the circular scanning grating 21, and FIGS. 4a and 4b are more detailed views of parts of the scanning grating 21, including a cross-sectional view of the same. The part of the scanning grating 21 illustrated in FIG. 4b is also referred to below as the optical unit cell of the scanning grating 21.

Like the detector arrangement 25 described above, the scanning grating 21 is configured for 2D angle measurement. It is arranged as a transmissive, combined amplitude-phase grating, which includes a periodic arrangement of square grating regions 21.1, 21.2 along two orthogonal grating directions GR1, GR2, in which the grating regions 21.1, 21.2 are arranged differently and have different optical effects on the beam bundles incident on them. A combined amplitude-phase grating should be understood to be a grating that has both amplitude grating components and phase grating components. The particular configuration of the scanning grating 21 is described in more detail below.

In FIG. 3, EZ represents an elementary cell of the scanning grating 21 with a total of four grating regions 21.1, 21.2, from which the scanning grating 21 can be constructed by translation along the two grating directions GR1, GR2. In the illustrated example, the periodicities P_GR1, P_GR2 along the two grating directions GR1, GR2 are selected identically according to P_GR1=P_GR2=222.85 μm.

The optical unit cell of the scanning grating 21 illustrated in FIG. 4b has a periodicity of 157.58 μm. This determines the signal period of the position-dependent incremental signals generated via the detector arrangement D with regard to resulting angular changes.

In each grating region 21.1, 21.2 of the scanning grating 21, an identically formed, opaque amplitude grating structure 21.3 is arranged on a carrier substrate 21.4, as illustrated, for example, in FIG. 4b. The amplitude grating structure includes opaque grating bars 21.3_G, which are arranged parallel to one another along the two grating directions GR1, GR2 and have at least partially different grating bar widths.

In each grating region 21.1, 21.2, the amplitude grating structure is identical and symmetrical with respect to the center M of the respective grating region. Furthermore, in grating regions 21.1, 21.2 arranged adjacent along a grating direction GR1, GR2, the amplitude grating structures are respectively formed mirror-symmetrically to an axis of symmetry SG1, SG2, SG3, SG4, which extends along the boundary of the adjacent grating regions 21.1, 21.2. FIG. 4b illustrates, for example, how the widths of the opaque grating bars in the central grating region 21.2 and the adjacent grating region 21.1 at the bottom left have a mirror symmetry with respect to the axis of symmetry SG1. Similarly, the grating bar widths in the other adjacent three other grating regions 21.1 are formed with respect to the axes of symmetry SG2, SG3, and SG 4. This is also illustrated in relation to the axis of symmetry SG1 in the cross-sectional view of the scanning grating at the bottom right in FIG. 4b. As illustrated, the amplitude grating structure is identical in all grating regions 21.1, 21.2.

An amplitude grating structure 21.3 formed in this manner ensures that the scanning grating 21 is relatively similar to the ideal sinusoidal grating and that for a certain wavelength range a preferential transmission into the +/−1st diffraction orders results. Higher odd-numbered diffraction orders, which may have a negative effect on the quality of the generated signals, are largely suppressed.

In each second grating region 21.2 along the two grating directions GR1, GR2, a phase shift layer 21.5 is arranged over the entire surface of the amplitude grating structure 21.3, as illustrated in the cross-sectional view in FIG. 4b. The periodicity of the phase shift layer 21.5 thus corresponds to the periodicities P_GR1 and P_GR2 with which the two grating regions 21.1, 21.2 are arranged along the two grating directions GR1, GR2.

For example, tantalum pentoxide Ta₂O₅ with a refractive index n=2.122 can be used as the material for the phase shift layer 21.5 in the scanning grating 21. With a selected height h=351 nm, this material can ensure that both the 0th diffraction order and all even diffraction orders are suppressed with incident radiation in the wavelength range 850 nm+/−20 nm and an angle of incidence between 0° and 50°. For an average angle of incidence of approximately 30°, the phase shift layer 21.5 has a phase deviation of 180°. By forming the grating regions 21.2 in this manner, further diffraction orders, which also have a negative effect on the signal quality, can be eliminated. Thus, in the device described herein, only the +/−1st diffraction orders contribute to signal generation.

The cross-sectional view in FIG. 4b illustrates the structure of the scanning grating 21 in more detail. On the upper side of the carrier substrate 21.4, in the two grating areas 21.1, 21.2, the amplitude grating structure 21.3 described above with the opaque grating bars 21.3_G is arranged, and in the grating areas 21.2, the phase shifting layer 21.5 is arranged. On the opposite side of the carrier substrate 21.4, i.e., on its underside, there is an additional anti-reflective layer 21.6 provided over the entire surface.

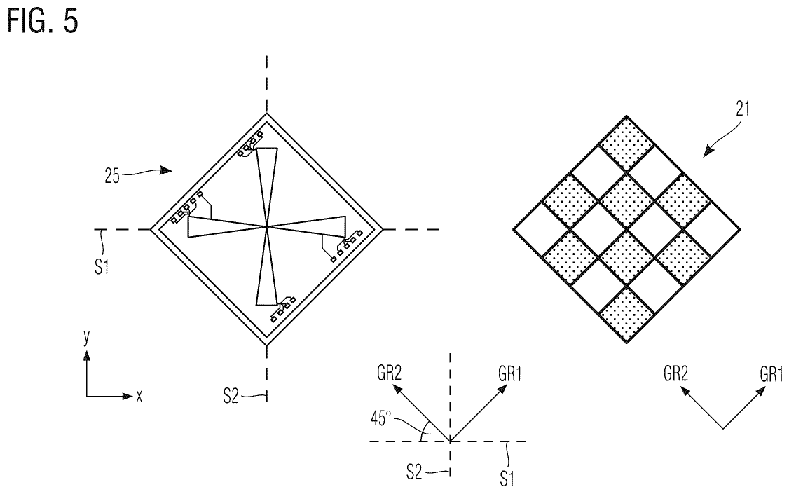

FIG. 5 illustrates how the detector arrangement 25 described above and the scanning grating 21 in the optical receiving unit of the position measuring system may be arranged relative to one another. The corresponding relative arrangement represents a further measure for filtering unwanted influences on the generated signals, e.g., for 2D angle measurement. FIG. 5 illustrates side-by-side top views of the detector arrangement 25 and the scanning grating 21. As explained with reference to FIG. 1, the scanning grating 21 with the periodic arrangement of grating regions 21.1, 21.2 along the two grating directions GR1, GR2 is arranged in a plane parallel to the detection plane and spaced at a distance d in the housing of the receiving unit.

As illustrated in FIG. 5, the scanning grating is arranged such that the two grating directions GR1, GR2 respectively form an angle of 45° to the longitudinal extension directions x, y of the detector regions 21.1 to 21.4. Such a relative arrangement of the scanning grating 21 and detector arrangement 25 can prevent a complete loss of signal at certain angles of incidence of the light source beam bundles on the scanning grating. In other words, this measure ensures that reliable 2D angle measurement is possible over the entire measuring range.

While the example described above provides for a 2D angle measurement in space, a configuration of the optical position measuring system is also possible in which only a 1D angle measurement is carried out between the light source and the optical receiving unit in a measuring plane.

For example, in connection with 1D angle measurement, only two of the four detector regions 25.1 to 25.4 illustrated in FIG. 2a are used on the detector arrangement side, namely two opposite detector regions such as the detector regions 25.1, 25.2 extending along the y-direction.

In such a configuration, the scanning grating includes a periodic arrangement of grating regions along only one grating direction, in which the grating regions are again arranged as a combined amplitude-phase grating. Each grating region also has an amplitude grating structure, and a phase shift layer is arranged above the amplitude grating structure in every second grating region. For example, the amplitude grating structure is not a two-dimensional structure as explained above, but is a one-dimensional arrangement of opaque grating bars with partially different grating bar widths provided along the grating direction. For example, the grating direction corresponds to the arrangement direction of the detector elements in the two detector regions 25.1, 25.2, i.e., the direction x illustrated in FIG. 2a. The grating bars are thus aligned parallel to the detector elements. The grating bars are again arranged such that, as in the example described above, undesirable odd-numbered diffraction orders are suppressed. For this purpose, a mirror-symmetrical arrangement of the grating bars is provided in relation to an axis of symmetry that extends through the boundary of adjacent grating regions.

What is claimed is:

1. A position measuring system for determining spatial position information, comprising:
at least one light source; and
at least one optical receiver unit including a scanning grating and an optoelectronic detector arrangement having light-sensitive surfaces oriented in a direction of the scanning grating;
wherein the detector arrangement includes two first detector regions arranged in a detection plane mirror-symmetrically to a first axis of symmetry that extends through a center of the detector arrangement in the detection plane, the first axis of symmetry being oriented orthogonally to a longitudinal extension direction of the first detector regions; and
wherein each of the first detector regions is shaped as an isosceles, acute-angled triangle having an apex, with an apex angle, oriented in a direction of the center of the detector arrangement.

2. The position measuring system according to claim 1, wherein the detector arrangement includes two further detector regions arranged identically to the two first detector regions and arranged mirror-symmetrically to a second axis of symmetry that extends in the detection plane through the center of the detector arrangement and that is oriented orthogonally to the first axis of symmetry.

3. The position measuring system according to claim 1, wherein the following relationship is satisfied:
$$γ / 2 = 7.12 {5}^{∘} + / - {5}^{∘} ,$$
γ representing the apex angle, the apexes, with the apex angle, touching one another in the center of the detector arrangement.

4. The position measuring system according to claim 1, wherein each detector region includes a plurality of individual detector elements arranged periodically and parallel to one another along an arrangement direction oriented perpendicular to the longitudinal extension direction of the detector regions.

5. The position measuring system according to claim 4, wherein each detector element is rectangular in shape and has a rectangle longitudinal axis oriented parallel to the longitudinal extension direction of the detector region, and every fourth detector element is electrically interconnected along the arrangement direction, so that four phase-shifted output signals for further processing result from scanning of a stripe pattern falling on the detector arrangement.

6. The position measuring system according to claim 5, wherein a ratio of detector element width and detector element periodicity is 1:7.

7. The position measuring system according to claim 5, wherein, for a change in detector element length along the arrangement direction, the following relationship is satisfied:
$$dh\_D / dx = + / - 8 ,$$
h_D representing the detector element length, x representing the arrangement direction.

8. The position measuring system according to claim 1, wherein the scanning grating is arranged in a plane parallel to the detection plane and includes a periodic arrangement of grating regions along at least one grating direction that is arranged at an angle of 45° to the longitudinal extension direction of the detector regions.

9. The position measuring system according to claim 8, wherein the scanning grating is arranged as a transmissive, combined amplitude-phase grating, an identically formed, opaque amplitude grating structure being arranged in each grating region, a phase shift layer being arranged along each grating direction in every second grating region above the amplitude grating structure.

10. The position measuring system according to claim 9, wherein a material and a layer thickness of the phase shift layer results in suppression of 0th diffraction order and all even diffraction orders for a predetermined wavelength range and for a predetermined angle of incidence range.

11. The position measuring system according to claim 9, wherein the amplitude grating structure is configured for preferential transmission into +/−1st diffraction orders and suppression of odd diffraction orders for a predetermined wavelength range.

12. The position measuring system according to claim 1, wherein the scanning grating is arranged on a side of a transparent cover plate of the receiver unit that is oriented in a direction of the detector arrangement.

13. The position measuring system according to claim 9, wherein the combined amplitude-phase grating has a checkerboard configuration with a periodic arrangement of square grating regions along two orthogonal grating directions.

14. The position measuring system according to claim 13, wherein the amplitude grating structure includes opaque grating bars arranged parallel to one another along the two grating directions and having at least partially different grating bar widths, the amplitude grating structures in grating regions that are arranged adjacent along a respective grating direction are arranged mirror-symmetrically to an axis of symmetry that extends along a boundary of the adjacent grating regions.

15. The position measuring system according to claim 1, wherein the light source includes an LED adapted to emit radiation in a wavelength range λ=850 nm+/−20 nm and having a coherence length of less than or equal to 7 μm.

16. The position measuring system according to claim 2, wherein the following relationship is satisfied:
$$γ / 2 = 7.12 {5}^{∘} + / - {5}^{∘} ,$$
γ representing the apex angle, the apexes, with the apex angle, touching one another in the center of the detector arrangement.

17. The position measuring system according to claim 1, wherein the light source and the optical receiver unit are movable relative to each other.

18. The position measuring system according to claim 10, wherein the material of the phase shift layer includes titanium pentoxide.
